(19) United States
(12) Patent Application Publication
(10) Pub. No.: US 2026/0200634 A1
(43) Pub. Date: Jul. 16, 2026

(54) METHOD OF FORMING A CLOSURE ASSEMBLY FOR A CONTAINER

(71) Applicant: Ardagh Metal Packaging Europe GmbH, Zug (CH)

(72) Inventors: Udo Jöbges, Düren (DE); Hajo Rieck, Hennef (DE)

(21) Appl. No.: 19/139,272

(22) PCT Filed: Dec. 8, 2023
(86) PCT No.: PCT/EP2023/084989

§ 371 Date: Jun. 13, 2025

(30) Foreign Application Priority Data
Dec. 16, 2022 (DE) 10 2022 133 590.9

(51) Int. Cl. B65D 17/50

(52) U.S. Cl. CPC B65D 17/506

(57) ABSTRACT

Method for forming a closure arrangement for a container, the closure arrangement having at least one lid element with an opening and a closure element arranged on the lid element for the repeatable closure of the opening, the closure element comprising a plurality of components which can be moved relative to one another; wherein the lid element has an outer side and an inner side and the opening has an opening edge and an opening plane formed by the opening edge; wherein the closure element has, as a first component, at least one frame part with a window which is non-detachably arranged on the opening edge.

The present invention relates to a method for forming a closure arrangement for a container, in particular a beverage container, preferably a beverage can.

The closure arrangement comprises at least one lid element with an opening and a non-detachable closure element arranged on the lid element for repeatable, in particular gas-tight, closure of the opening. The lid element is made of metal in particular. The container is used to store contents, e.g. a fluid, whereby the beverage container is under overpressure when closed.

Beverage cans with carbonated contents in particular can be under an internal pressure of up to 6.2 bar before they are opened for the first time.

Both single-opening and reclosable closure arrangements are known for closing such beverage containers. The advantage of reclosable closure arrangements is obvious. This means that a beverage container can be closed even after partial emptying, in particular in a gas-tight manner, so that the fluid stored in the beverage container is prevented from escaping and, particularly in the case of carbonated contents, the carbonation is prevented from escaping.

In particular, a captive arrangement of the closure arrangement on the lid element or on the container is desired, so that all components of the beverage container can be fed into a recycling process.

With the high quantities of such containers, a short cycle time and a reproducible process for positioning the closure element on the lid element is desirable.

DE 10 2021 106 977 A1 discloses a closure arrangement for a beverage container and a method for the repeatable closure of a beverage container with a closure arrangement.

DE 10 2021 106 980 A1 discloses a lid element for a beverage container and a closure arrangement for a beverage container.

A method for manufacturing a closure element for a container and a closure arrangement are known from DE 10 2022 123 526A1 .

The task of the invention is to at least partially solve the problems existing with reference to the state of the art and, in particular, to propose a method for forming a closure arrangement for a container, wherein the connection of the closure element to the lid element can be carried out reproducibly with high quality and with a short cycle time.

In particular, a closure element of the closure arrangement should be captively arranged or attached to the container.

Furthermore, it should also be possible to reclose the beverage container by the closure arrangement after it has been opened for the first time, whereby a tightness of the container (with respect to an atmospheric pressure) should be ensured on the one hand at a low pressure in the container and on the other hand even at a pressure inside the container of up to 6.2 bar.

These tasks are solved with a method according to the features of claim 1. Further advantageous embodiments of the method are given in the dependent claims. It should be noted that the features listed individually in the dependent claims can be combined with each other in a technologically meaningful way and define further embodiments of the invention. In addition, the features specified in the claims are further specified and explained in the description, whereby further preferred embodiments of the invention are shown.

A method for forming a closure arrangement for a container is proposed, wherein the closure arrangement has at least one lid element with an opening and a closure element arranged on the lid element for repeatably closing the opening. The closure element comprises a plurality of components that can be moved relative to one another. The lid element has an outer side and an inner side and the opening has an opening edge and an opening plane formed by the opening edge. As a first component, the closure element has at least a frame part with a window, the frame part being non-detachably arranged on the opening edge. The method comprises at least the following steps:
a) Providing the lid element with the opening;
b) Providing the frame part;
c) Arranging the frame part in the opening, with the frame part extending on both sides of the opening plane;
d) plastic deforming of at least a subsection of the frame part consisting of a plastic material, so that the frame part extends around at least a part of the opening edge, so that an inseparable positive first connection is formed between the frame part and the lid element with respect to an axial direction extending transversely to the opening plane.

The deforming is a cold forming process.

The above (non-exhaustive) classification of the process steps into a) to d) is intended primarily for differentiation purposes only and is not intended to enforce any sequence and/or dependency. The frequency of the process steps may also vary. It is also possible for process steps to at least partially overlap in time. Process steps a) and b) are particularly preferred to take place before step c). In particular, step c) takes place before step d). In particular, steps a) and b) take place simultaneously. In particular, steps a) to d) are carried out in the stated sequence.

In particular, the closure arrangement can be designed as described in DE 10 2021 106 977 A1 and manufactured as described in DE 10 2022 123 526A1.

In particular, the closure element comprises at least or comprises exclusively a base part (first component), a lever (third component) and a cover (second component). The base part has a frame part with a window, the frame part being arranged at the opening edge. The lever is (exclusively) connected to the frame part via (and pivotable about) a first axis of rotation. In an initial position of the locking arrangement, the cover closes the window and is (exclusively) connected to the frame part via a second axis of rotation (and pivotable about this) or pivotable via a hinge. The lever is (directly) connected to the cover (and thereby) permanently (i.e. while the closure arrangement is in a state intended for the predetermined operation) via a guiding device. The cover can be pivoted via the guiding device by pivoting the lever about the first axis of rotation, starting from the initial position about the second axis of rotation or about the hinge into an opening position of the closure arrangement that releases the window, and back again into the initial position.

In particular, the first component (frame part) has a gasket that seals the connection between the first component and the lid element. In particular, this gasket extends all the way around the opening along the opening edge.

In particular, a gasket is arranged between the first component (frame part) and the second component (cover) that surrounds the window of the frame part, at least in the initial position. This gasket makes it possible to seal the window or the opening by means of a sealing connection between the cover and the frame part. In particular, the gasket is arranged on the frame part or on the cover.

In particular, these gaskets can be manufactured or are manufactured together with the frame part, and possibly also with the second component, and/or with the third component, as part of a two-component injection molding process.

In particular, the first component and/or the second component and/or the third component is made of a plastic with a modulus of elasticity of at least 1100 MPa [Megapascals], in particular of at least 1300 MPa, preferably of at least 1600 MPa.

Preferably, the gaskets are made of a plastic with a Shore A hardness of at most 60, in particular at most 45, preferably at most 35.

The lid element can be designed in particular as described in DE 10 2021 106 980A1.

In particular, not only the frame part but also the closure element is provided in step b).

In particular, the frame part is arranged in the opening in step c), whereby the other components of the closure element are also arranged on the lid element via the frame part.

In particular, steps a) to c) take place outside a press, in which step d) in particular is carried out. In particular, the closure arrangement, i.e. the lid element and the closure element arranged thereon, is arranged in a press as part of step d), with cold forming then taking place in the press.

Such a frame part is usually connected to the lid element via a positive first connection that extends along the opening edge of the and can only be detached from the opening edge by destroying the frame part. Such a frame part is mounted on the opening edge via plastic deformation of the frame part. DE 10 2021 106 977 A1 states that this plastic deformation can be carried out, for example, by thermal treatment of the frame part, e.g. at least local heating.

In the case of hot forming (temperature at the tool or in the area to be deformed, e.g. at least 30 degrees Celsius above ambient temperature), the heat can only reach the material to be deformed via mechanical contact. Heating the material to be deformed, e.g. via induction, hot air, etc., is disadvantageous, as the areas of the component that are not to be deformed are also heated and would be subject to undesirable deformation.

When heating via mechanical contact, i.e. via the heated tool, the cycle time or process time for deforming the component increases to more than one second.

Another problem with hot forming is that the deformed material of the component only has a low strength and therefore does not remain in the position changed by the deforming process. It would then be necessary to re-form it using a cold tool arranged downstream.

In the proposed cold forming process, in which no additional heat is introduced into the material, whether by contact with a heated tool or by radiation, etc., it was surprisingly found that no deformation of the deformed subsection occurred. The otherwise typical white fracture that occurs when “normal” cold forming is overstressed also does not occur.

In particular, it is possible to produce the first connection in just one process step, i.e. with just one tool or one tool stroke, and without heating the material to be deformed, whereby a high quality of the first connection and a short cycle time or process time can be realized.

In particular, for example, a traversing speed of the deforming tool is selected so that heat is generated in the material to be deformed by the internal friction of the molecular chains during the deforming process. However, this heat does not penetrate measurably to the surface of the deformed subsection, so that successive heating of the tool does not occur. The highest temperatures are in the core of the material or the subsection, i.e. at a distance from the surfaces, whereby this favors the good dimensional stability achieved.

In order to enable cold forming, it is particularly important that the material undergoes a minimum amount of deformation. If, for example, in the hot deforming process described above, the aforementioned secondary deforming is carried out using a cold tool, this secondary deforming cannot generate the required heat that is generated in the material itself.

In particular, the deforming according to step d) takes place in a press, wherein the lid element together with the closure element are arranged in a receptacle of the press and then the forming takes place by the movement of at least one punch (the tool). The tool therefore comprises, for example, a punch of a (forming) press. In particular, several punches can also be provided, through which the deforming takes place. Furthermore, the press can comprise fixing devices by means of which the lid element is fixed in the press together with the closure element.

The at least one punch, by means of which the deforming of at least the subsection takes place, moves in particular exclusively along a straight line, in particular along the axial direction.

In this case, the deforming cycle time includes in particular the infeed movement of the tool and the deforming itself, i.e. the movement of the at least one tool (punch) to deform the subsection or possibly further regions of the closure element, and the return movement of the tool to an initial position.

In addition to the cycle time, the process time also includes the time for inserting and removing the lid element and the closure element from the press.

In particular, the subsection to be deformed has a minimum wall thickness of at most 2.0 millimeters, in particular at most 1.8 millimeters or at most 1.5 millimeters in the region of the deforming. In particular, the subsection to be deformed has a minimum wall thickness of at least 0.2 millimeters, preferably at least 0.5 millimeters, in the region of the deforming. In particular, the wall thickness in the region of the deforming is essentially constant.

In particular, the tool used for deforming covers a path along the axial direction of at most 3.0 millimetres, preferably at most 2.5 millimetres, particularly preferably at most 2.0 millimetres or even less than 2.0 millimetres, after initial contact with the partial area. The path is in particular at least 1.0 millimeters, preferably at least 1.5 millimeters.

The path refers to the distance along the axial direction during which the tool makes contact with the subsection. The infeed movement of the tool, i.e. from an initial position of the tool to a position in which the tool makes contact with the subsection, is not included.

In particular, the tool used for deforming is operated in a path-controlled manner. Path-controlled means in particular that the tool is controlled only by its position along the axial direction. This ensures that the tool covers the predetermined path.

In particular, a path traveled by the tool for deforming is limited by a mechanical stop. In particular, the tool therefore moves against a stop and is not braked by the closure element or the lid element. In particular, the stop is part of the press and is reused for each new closure arrangement.

In particular, the subsection is deformed in less than 0.005 seconds, preferably in less than 0.002 seconds, particularly preferably in less than 0.001 seconds. This time corresponds in particular to the cycle time, i.e. also includes the travel of the tool from and back to an initial position.

In particular, the tool used for deforming is moved at a traversing speed of at least 800 millimeters per second, preferably at least 1,000 millimeters per second, particularly preferably at least 1,200 millimeters per second, at least during the deforming of the subsection.

In particular, a maximum forming force occurring during deforming has a value in a range between 2,000 and 10,000 newtons, in particular in a range between 3,000 and 8,000 newtons.

In particular, the material of the subsection is (only) heated locally as a result of the deforming, with a highest temperature of the material being present in an area of the material that is spaced apart from a surface of the subsection. In particular, the heating occurs exclusively due to the internal friction of the material caused by the deforming.

In particular, the subsection extends along the opening edge over an angular range of at least 180 angular degrees, preferably at least 230 or even at least 270 angular degrees. In particular, the subsection extends along the opening edge over an extension of at least 20 millimeters, preferably at least 25 millimeters, in particular at most 40 millimeters.

In particular, several subsections of the frame part are deformed in parallel in step d). In particular, these subsections are spaced apart from one another.

In particular, the closure element additionally comprises at least one second component which can be pivoted relative to the frame part in order to open the container. In particular, in step d), a deformation region of the second component or of the frame part is deformed so that at least one positive second connection, which hinders the pivoting, is formed between at least two components of the closure element. In particular, this second connection is broken when the closure element is opened for the first time, so that the at least one second connection creates, on the one hand, a safeguard against unintentional opening of the closure element and, on the other hand, a freshness seal. The freshness seal is used in particular to signal whether a container has already been opened. If the freshness seal is intact, it can be assumed that the container has not been opened again after it has been closed for the first time.

In particular, the deforming of the deforming region is also performed by a punch of a press, in particular by the same punch of the press by which the subsection is deformed. In particular, the deforming of the deforming region takes place at least during the same movement of the one punch that it executes to deform the subsection. In particular, the deforming of the deforming region takes place at the same time or at least partially overlapping with the deforming of the subsection.

In particular, the closure element comprises a third component that can be pivoted relative to the frame part and the second component in order to open the container, with the or at least a second connection being formed between the second component and the third component (i.e. between the cover and the lever, for example). Alternatively or additionally, the or at least a second connection is formed between the first component (frame part or base part) and the second or third component (i.e. the cover or the lever).

In particular, the lid element is a known lid, e.g. of a beverage can, which is connected or can be connected to the beverage can. Preferably, the lid element is inseparably (only destructively) connected to the beverage container. In particular, the lid element consists of a metal or a metallic alloy.

The inner side of the lid element forms the side of the lid element facing the contents of the beverage container, while the outer side of the lid element forms the side of the lid element facing away from the contents.

In particular, the opening of the lid element is also the (only) pouring opening for the contents of the beverage container. In particular, the shape of the opening is not fixed. In particular, the opening is not rotationally symmetrical. However, a rotationally symmetrical opening can also be closed via the closure element described here and is thus encompassed by the term opening.

In particular, the first component (frame part) is stationary and immovably arranged on the opening edge. The other components of the closure element are connected to the lid element via the frame part. These other components are arranged so that they can move relative to the first component. In particular, the closure element enables a repeatable gas-tight closure of the opening. In particular, the closure element therefore not only enables the opening to be closed or sealed liquid-tight, but also enables it to be sealed gas-tight. This means that the opening can be effectively sealed even after the closure element has been opened for the first time, particularly in the case of carbonated liquids.

In particular, at least a system for data processing is provided, which has means which are suitably equipped, configured or programmed to carry out the method or which carry out the method.

In particular, a production plant comprises a system for data processing, for example a control unit, which has means for carrying out the steps of the method and/or which has means which are suitably equipped, configured or programmed to carry out the steps of the method or which carry out the method.

In particular, the production plant can be used to provide the closure arrangement or the lid element and the frame part (or the entire closure element) and to arrange them in a press. In particular, the press can also be controlled via the system.

The means comprise, for example, a processor and a memory in which instructions to be executed by the processor are stored, as well as data lines or transmission devices which enable the transmission of instructions, measured values, data or the like between the aforementioned elements.

In particular, the means may comprise one or more of the following components: controller(s), microcontroller, data memory, data link, display devices (such as a display), counter or timer, at least one further sensor, an energy source, etc.

There is further proposed a computer program comprising instructions which, when the program is executed by a computer, cause the computer to perform the described method or the steps of the described method.

There is further proposed a computer-readable storage medium comprising instructions which, when executed by a computer, cause this to carry out the described method or the steps of the described method.

The embodiments of the method are particularly transferable to the system for data processing and/or the computer-implemented method (i.e. the computer program and the computer-readable storage medium) and vice versa. The use of indefinite articles (“a”, “an”) in particular in the claims and the description reproducing them, is to be understood as such and not as a number word. Accordingly, terms or components introduced in this way are to be understood as being present at least once and, in particular, may also be present more than once.

By way of precaution, it should be noted that the numerical words used here (“first”, “second”, . . . ) primarily serve (only) to distinguish between several similar objects, quantities or processes, i.e. in particular they do not necessarily specify any dependency and/or sequence of these objects, quantities or processes in relation to one another. If a dependency and/or sequence is required, this is explicitly stated here or is obvious to the person skilled in the art when studying the specific embodiment described. Insofar as a component may occur more than once (“at least one”), the description of one of these components may apply equally to all or some of the plurality of these components, but this is not mandatory.

The invention and the technical environment are explained in more detail below with reference to the enclosed figures. It should be noted that the invention is not intended to be limited by the embodiment examples given. In particular, unless explicitly shown otherwise, it is also possible to extract partial aspects of the matters explained in the figures and to combine them with other components and findings from the present description. In particular, it should be noted that the figures and especially the proportions shown are only schematic. It shows:

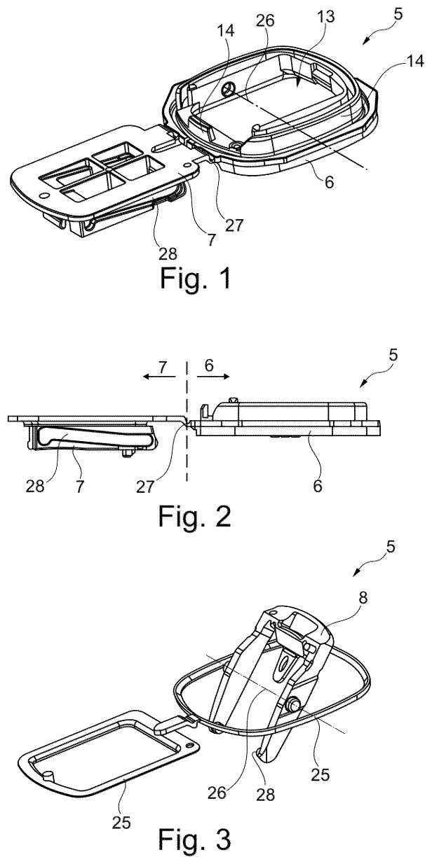

FIG. 1: a part of the closure element in a perspective view;

FIG. 2: the part shown in FIG. 1 in a side view;

FIG. 3: a further part of the closure element in a perspective view;

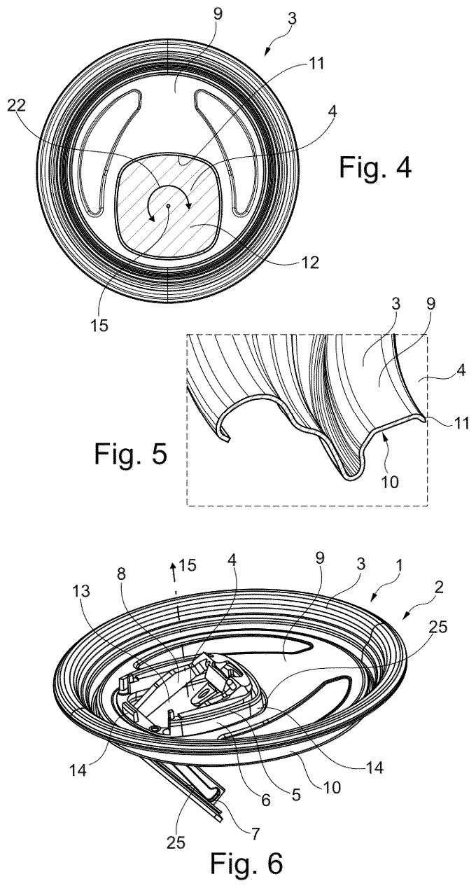

FIG. 4: a lid element in a top view;

FIG. 5: a detail of the lid element in a perspective view in section;

FIG. 6: a container with a closure arrangement;

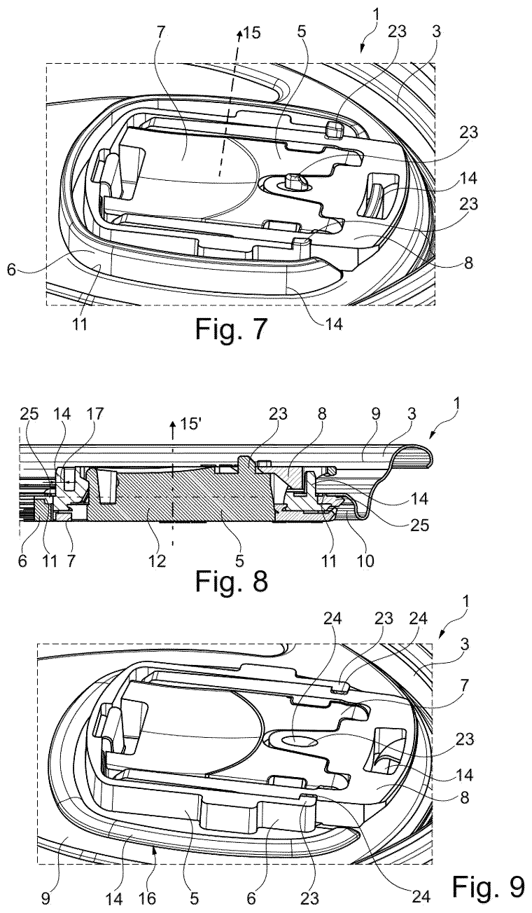

FIG. 7: the closure arrangement according to FIG. 6 in a perspective view in section;

FIG. 8: the closure arrangement according to FIGS. 6 and 7 in a side view in section;

FIG. 9: the closure arrangement according to FIGS. 6 to 8 in a perspective view, after cold forming of the frame part;

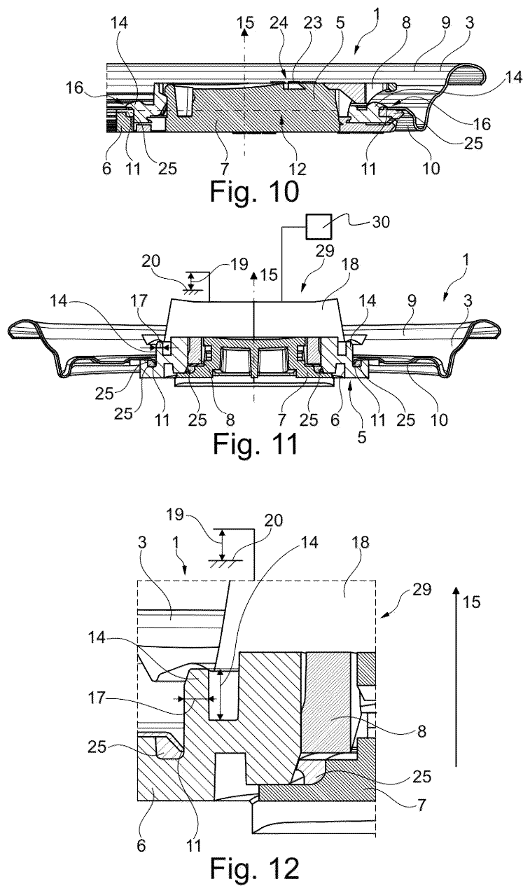

FIG. 10: the closure arrangement according to FIG. 9 in a side view in section;

FIG. 11: the closure arrangement according to FIGS. 6 to 8 in a press, immediately before step d), in a side view in section;

FIG. 12: a detail of FIG. 11;

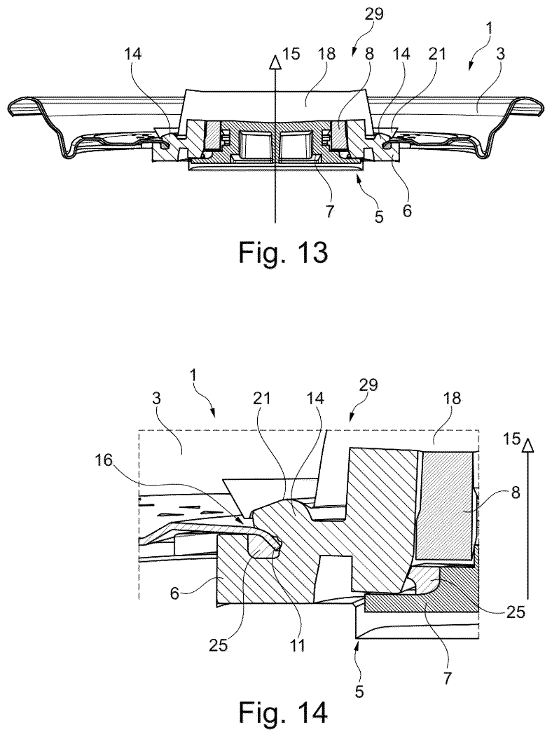

FIG. 13: the closure arrangement according to FIGS. 9 and 10 in a press, during step d), in a side view in section; and

FIG. 14: a detail of FIG. 13.

FIG. 1 shows a part of the closure element 5 in a perspective view. FIG. 2 shows a side view of the part shown in FIG. 1. FIG. 3 shows a further part of the closure element 5 in a perspective view. FIGS. 1 to 3 are described together below.

The closure element 5 has a base part (first component 6), a lever (third component 8) and a cover (second component 7). The base part has a frame part 6 arranged on the opening edge 11 with a window 13. The lever is connected to the frame part 6 via a first axis of rotation 26 and is pivotable about this axis. In an initial position of the closure arrangement 1, the cover closes the window 13 and is pivotably connected to the frame part 6 exclusively via a hinge 27. The lever is connected directly to the cover and permanently (i.e. while the closure arrangement 1 is in a state intended for predetermined operation) via a guiding device 28. Via the guiding device 28, the cover can be pivoted by a pivoting of the lever about the first axis of rotation 26, starting from the initial position about the hinge 27 into an opening position of the closure arrangement 1, which releases the window 13, and back again into the initial position.

The first component 6 (frame part) has a gasket 25, which seals the connection between the first component 6 and the lid element 3 (see FIG. 4). This gasket 25 extends all the way around the opening 4 along the opening edge 11.

A gasket 25 is arranged between the first component 6 (frame part) and the second component 7 (cover) and surrounds the window 13 of the frame part 6, at least in the initial position. This gasket 25 makes it possible to seal the window 13 or the opening 4 by means of a sealing connection between the cover and the frame part 6. This gasket 25 is arranged on the cover.

These gaskets 25 are produced in a two-component injection molding process together with the third component 8 (see FIG. 3).

The parts of the closure element 5 shown in FIGS. 1 to 3 are joined together to form the closure element 5 and can thus be arranged on the lid element 3 via the frame part 6.

FIG. 4 shows a top view of a lid element 3. FIG. 5 shows a detail of the lid element 3 in a perspective view in section. FIG. 6 shows a container 2 with a closure arrangement 1. FIG. 7 shows the closure arrangement 1 according to FIG. 6 in a perspective view in section. FIG. 8 shows the closure arrangement 1 according to FIGS. 6 and 7 in a side view in section. FIG. 9 shows the closure arrangement 1 according to FIGS. 6 to 8 in a perspective view, after cold forming of the frame part 6. FIG. 10 shows the closure arrangement 1 according to FIG. 9 in a side view in section. FIGS. 4 to 10 are described together below. Reference is made to the explanations on FIGS. 1 to 3.

The closure arrangement 1 comprises a lid element 3 with an opening 4 and a closure element 5 arranged on the lid element 3 for the repeatable closure of the opening 4. The closure element 5 comprises a plurality of components 6, 7, 8 which are movable relative to one another. The lid element 3 has an outer side 9 and an inner side 10 and the opening 4 has an opening edge 11 and an opening plane 12 formed by the opening edge 11. As a first component 6, the closure element 5 has a frame part 6 with a window 13 that is non-detachably arranged on the opening edge 11 (see FIGS. 9 to 13).

The frame part 6 has a subsection 14 which is cold-formed as part of the process and thus forms a first connection 16 between the frame part 6 and the lid element 3.

The subsection 14 extends along the opening edge 11 over an angular range 22 that covers approximately 300 angular degrees.

The frame part 6 has several subsections 14, which are arranged at a distance from one another. In step d), several subsections 14 of the frame part 6 are deformed in parallel.

The closure element 5 additionally comprises a second component 7 that can be pivoted relative to the frame part 6 to open the container 2. In step d), deforming regions 23 of the second component 7 and the frame part 6 are deformed so that several positive second connections 24 (see FIG. 9), which hinder the pivoting, are formed between two components 6, 7, 8 of the closure element 5 in each case. These second connections 24 are broken when the closure element 5 is opened for the first time, so that the second connections 24 create, on the one hand, a safeguard against unintentional opening of the closure element 5 and, on the other hand, a freshness seal.

The closure element 5 comprises a third component 8 that can be pivoted relative to the frame part 6 and the second component 7 in order to open the container 2, whereby a second connection 24 is formed between the second component 7 and the third component 8 (i.e. between the cover and the lever, for example). In addition, two second connections 24 are formed between the first component 6 (frame part or base part) and the third component 8 (i.e. the lever).

FIG. 11 shows the closure arrangement 1 according to FIGS. 6 to 8 in a press 29, immediately before step d), in a side view in section. FIG. 12 shows a detail of FIG. 11. FIG. 13 shows the closure arrangement 1 according to FIGS. 9 and 10 in a press 29, during step d), in a side view in section. FIG. 14 shows a detail of FIG. 13. FIGS. 11 to 14 are described together below. Reference is made to the explanations on FIGS. 1 to 10.

In step d), the subsections 14 of the frame part 6 consisting of a plastic material are plastically deformed, so that the frame part 6 extends around at least a part of the opening edge 11, so that an inseparable positive first connection 14 is formed between the frame part 6 and the lid element 3 with respect to an axial direction 15 extending transversely to the opening plane 12. The deforming is a cold forming process.

A traversing speed of the forming tool 18 is selected so that heat is generated in the material to be deformed by the internal friction of the molecular chains during the deforming process. However, this heat does not penetrate measurably to the surface 21 of the deformed subsection 14, so that successive heating of the tool 18 does not occur. The highest temperatures are in the core of the material or the subsection 14, i.e. at a distance from the surfaces 21, whereby this favors the good dimensional stability achieved.

The deforming according to step d) takes place in a press 29, wherein the lid element 3 together with the closure element 5 are arranged in a receptacle (not shown) of the press 29 and then the deforming takes place by the movement of at least one punch (the tool 18). The tool 18 thus comprises a punch of a (forming) press. Several punches can also be provided, through which the deforming takes place. Furthermore, the press 29 can comprise fixing devices by means of which the lid element 3 together with the closure element 5 are fixed in the press 29.

The press 29 is controlled via the system 30.

The cycle time of the forming comprises the feed movement of the tool 18 and the forming itself, i.e. the movement of the at least one tool 18 (punch) for deforming the subsection 14 or possibly further regions 14, 23 of the closure element 5 as well as the return movement of the tool 18 to an initial position.

In addition to the cycle time, the process time also includes the time for inserting and removing the lid element 3 and the closure element 5 from the press 29.

The subsection 14 to be deformed has a minimal wall thickness 17 in the forming area. The tool 18 used for deforming covers a path 19 along the axial direction 15 after initial contact with the subsection.

The path 19 denotes the distance along the axial direction 15 during which the tool 18 contacts the subsection 14 (i.e. between the position of the tool 18 as shown in FIGS. 11, 12 and 13, 14). The infeed movement of the tool 18, i.e. from an initial position of the tool 18 to a position in which the tool 18 contacts the subsection 14 (see FIGS. 11, 12) is not included.

The tool 18 used for forming is operated in a path-controlled manner. A path 19 covered by the tool 18 for forming is limited by a mechanical stop 20. The tool 18 therefore moves against a stop 20 and is not braked or stopped by the closure element 5 or the lid element 3. The stop 20 is part of the press 29 and is reused for each new closure arrangement 1.

The deforming of the subsections 14 and the deforming areas 23 takes place in less than 0.005 seconds. This time corresponds to the cycle time, i.e. also includes the travel paths of the tool 18 from and back to an initial position.

The tool 18 used for forming is moved at a traversing speed of at least 800 millimeters per second at least during the deforming of the subsection 14. A maximum forming force occurring during forming has a value in the range between 2,000 and 10,000 newtons.

The material of the subsections 18 and the deforming areas 23 is (only) heated locally as a result of the deforming, with a highest temperature of the material being present in an area of the material which is arranged at a distance from a surface 21 of the subsection 14. The heating occurs exclusively due to the internal friction of the material caused by the deforming.

The subsection 14 extends along the opening edge 11 over an angular range 22, which comprises at least 180 angular degrees (see FIG. 4). In step d), several subsections 14 of the frame part 6 and deforming areas 23 of the closure element 5 are deformed in parallel.

### LIST OF REFERENCE SYMBOLS

1 Closure arrangement
2 container
3 lid element
4 opening
5 closing element
6 first component/frame part
7 second component
8 third component
9 outer side
10 inner side
11 opening edge
12 opening plane
13 window
14 subsection
15 axial direction
16 first connection
17 wall thickness
18 tool
19 path
20 stop
21 surface
22 angular range
23 deformation region
24 second connection
25 gasket
26 first axis of rotation
27 hinge
28 guiding device
29 press
30 system

1. A method of manufacturing a closure arrangement for a container, the closure arrangement comprising at least one lid element with an opening and a closure element arranged on the lid element and configured to repeatably close the opening, the closure element comprising a plurality of components configured to move relative to one another; wherein the lid element has an outer side and an inner side and the opening comprising an opening edge and an opening plane formed by the opening edge; wherein the closure element comprises a first component, comprising at least one frame part with a window, the frame part being non-detachably arranged on the opening edge, the method comprising:
providing the lid element with the opening;
providing the frame part;
arranging the frame part in the opening, wherein the frame part extends on both sides of the opening plane;
plasticly deforming at least a subsection of the frame part consisting of a plastic material, so that the frame part extends around at least a part of the opening edge, so that an inseparable positive first connection is formed between the frame part and the lid element with respect to an axial direction extending transversely to the opening plane
whereby plasticly deforming at least the subsection of the frame part is a cold forming process.

2. The method of claim 1, wherein the subsection to be deformed has a minimum wall thickness of at most 2.0 millimeters in the region of the deforming.

3. The method of claim 1, wherein plastically deforming the subsection comprises using a [[the ]]tool covering a path along the axial direction of at most 3.0 millimeters after initial contact with the subsection.

4. The method of claim 1, wherein plastically deforming the subsection comprises using a tool operated in a path-controlled manner.

5. The method of claim 4, path for the path-controlled tool is limited by a mechanical stop.

6. The method of claim 1, wherein the deforming of the subsection takes place in less than 0.005 seconds.

7. The method of claim 1, wherein plastically deforming the subsection comprises using a tool configured to move at a traversing speed of at least 800 millimeters per second.

8. The method of claim 1, wherein a maximum forming force occurring during deforming has a value in a range between 2,000 and 10,000 Newtons.

9. The method of claim 1, wherein plasticly deforming at least the subsection of the frame part heats at least a portion of the frame part, wherein a highest temperature of the material is present in a region of the material spaced apart from a surface of the subsection.

10. The method of claim 1, wherein the subsection extends along the opening edge over an angular region comprising at least 180 angular degrees.

11. The method of claim 1, wherein plastically deforming at least the subsection of the frame part comprises deforming several subsections of the frame part in parallel.

12. The method of claim 1, wherein the closure element additionally comprises at least one second component which is pivotable relative to the frame part for opening the container;
wherein plasticly deforming at least the subsection of the frame part comprises deforming a deformation region of the second component or of the frame part so that a second connection impeding the pivoting is formed between at least two components of the closure element.

13. The method of claim 12, wherein the closure element comprises a third component which is pivotable relative to the frame part and the second component for opening the container, wherein the second connection is formed between the second component and the third component.
